(19) United States
(12) Patent Application Publication
(10) Pub. No.: US 2008/0250449 A1
(43) Pub. Date: Oct. 9, 2008

(54) Method of dynamic product placement in prerecorded audio and video

(76) Inventor: Nick Torkos, Redwood City, CA (US)

Correspondence Address: NICK TORKOS, 560 OAK RIDGE DRIVE, REDWOOD CITY, CA, 94062, US

(21) Appl. No.: 11/784,016

(22) Filed: Apr. 5, 2007

(51) Int. Cl. H04N 7/025

(52) U.S. Cl. 725/34

(57) ABSTRACT

A method of dynamic product placement in prerecorded video or audio is disclosed. The method requires a means to decide when product placement should occur in the video or audio, a way to determine the content of a product placement advertisement in a section of video or audio, and software or hardware to alter sections of the video or audio data such that the new data includes new product placement. A preferred embodiment maintains the integrity of the original recording, allows for the product placement in the current playing of the content to appear different than what appeared in the original recording, and allows for product placement to change at different points in time.

### CROSS-REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of advertising and more specifically to a method of dynamic advertising in prerecorded audio and video. Several methods currently exist for advertising in prerecorded audio and video, namely playing commercials, utilizing product placement, implementing chroma keying methods, and incorporating methods from various patents. This section gives an overview of the current state of the art in audio and video advertising and explains how the existing methods are deficient in some way.

Commercials have always been a huge source of revenue for media companies, however, they are frequently an annoyance to audiences that would prefer to listen to the radio program or watch the rest of the television show or movie. In modern days, with the frequent use of digital recorders, the audience can easily skip over commercials to enjoy the rest of the show.

As an alternative to commercials, the entertainment industry often employs product placement to advertise within the show as a noninvasive method to generate revenue through advertisements without detracting from the audience's experience. This common advertising method is used to lower the cost of production when making movies, television shows or audio recordings. Product placement has a benefit over conventional advertising because with product placement, the advertisement is embedded into the original production in a seamless manner that does not disturb the viewer or listener. For example, in a movie an actor may drive a specific car or eat a bowl of a prominently displayed box of cereal. After many years, though, the advertisement in the original recording becomes old and fails to generate revenue for the creators of the program.

Another common and very successful advertising technique is emerging today on the Internet: contextual advertising. Contextual advertising involves directing advertisement content based on information that the user is exploring on a web page, the user's email content or past purchasing habits. Contextual advertising is successful because it targets advertisements based on the interests of the user. However, contextual advertising is generally text-based and does not apply to audio or video data unless it is shown as a commercial, interrupting the original audio or video data stream.

A fourth way to display advertisements in live programs is through the use of chroma keying techniques which seek a predetermined color or shape in the data and then map new data on top of it. For example, many televised baseball programs include a computer generated banner behind the home plate such that the banner looks as if it is an advertisement that exists in the stadium itself.

U.S. Pat. No. 20060265725 describes an advertisement method where an electronic device is used to merge video advertisement data with a video broadcast signal. This way a viewer can watch a show and also see advertisements in a particular section of the screen where the advertisements can be defined locally.

U.S. Pat. No. 20060253323 describes a method for targeting advertisements to television viewers in a way that allows the advertisements to change based on the current advertising bids.

U.S. Pat. No. 20070074243 describes a method of inserting commercials in time-shifted broadcast content.

While there exist many methods to advertise products, these methods have disadvantages. A disadvantage of commercials is that they detract from the original video or audio content, and thus annoy the audience. Also, commercials can be skipped. Product placement has the disadvantage of being immutable. Once the original recording is released, it cannot be changed. This results in advertisements becoming out of date and not generating revenue over time. Current contextual advertising methods are inadequate for video and audio data because they involve interrupting the video or audio with a commercial. Chroma keying techniques can be somewhat dynamic, however this method is often very contrived to work in specific instances where the information to be replaced with advertisement is easy to determine. It also has the problem of not being changeable once a recording has been made. U.S. Pat. No. 20060265725 is deficient because the advertisement takes up screen space and detracts from the original program. Also, it does not allow for generating continual advertisement revenue from a DVD or movie file. U.S. Pat. No. 20060253323 is deficient because while commercials can be dynamically selected, the advertisement is still a commercial and can be skipped when recorded, or interrupt the program and annoy the audience when viewed. U.S. Pat. No. 2007074243 is deficient because it is specific to live broadcast content and also because this patent still involves the display of commercials, which interrupt the program. Furthermore, none of these methods enable the content creator to generate revenue from pirated copies of the audio or video data.

### BRIEF SUMMARY OF THE INVENTION

In accordance with a preferred embodiment of the invention, there is disclosed a method of advertising in prerecorded video or audio comprising of: a means of deciding when advertisements should occur in the video or audio, a means of determining the content of an advertisement in a section of video or audio, a means of altering sections of video or audio data such that the new data includes information relating to the advertisements, and a player which utilizes these means to generate altered streamed video or audio data with relevant product placement.

### OBJECTS AND ADVANTAGES

The primary object of the invention is to provide a new revenue source for video and audio recordings, where product placement can be altered after the original recording has been made.

Another object of the invention is to provide a method where new product placement can be added into a previously recorded data stream.

A further object of the invention is to provide a method where product placement can be tailored to individuals based on the viewer's or listener's demographic or geographic location.

Yet another object of the invention is to provide a method where revenue can still be generated from pirated media.

One additional advantage is with the advent of digital video recorders, many viewers and listeners will not be able to skip the dynamic product placement without missing critical parts of their program.

Further objects and advantages of the present invention will become apparent from the following descriptions, taken in connection with the accompanying drawings, wherein, by way of illustration and example, an embodiment of the present invention is disclosed.

### DRAWING FIGURES

FIG. 1 shows the general view of how the advertising system works.

FIG. 2 shows an example of how a player could be implemented.

FIG. 3 shows an example of timing and location information for the advertisements.

FIG. 4 shows an example of how product placement in streaming media is currently played without the proposed system.

FIG. 5 shows an example of how product placement in streaming media can be played dynamically by using the proposed system.

FIG. 6 shows an example of how product placement in audio can be played dynamically by using the proposed system

FIG. 7 shows an example of how the proposed system would work using compositing techniques and digital effects.

### DETAILED DESCRIPTION OF THE PREFERRED EMBODIMENTS

Detailed descriptions of the preferred embodiment are provided herein. While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims. Therefore, specific details disclosed herein are not to be interpreted as limiting, but rather as a basis for the claims and as a representative basis for teaching one skilled in the art to employ the present invention in virtually any appropriately detailed system, structure or manner.

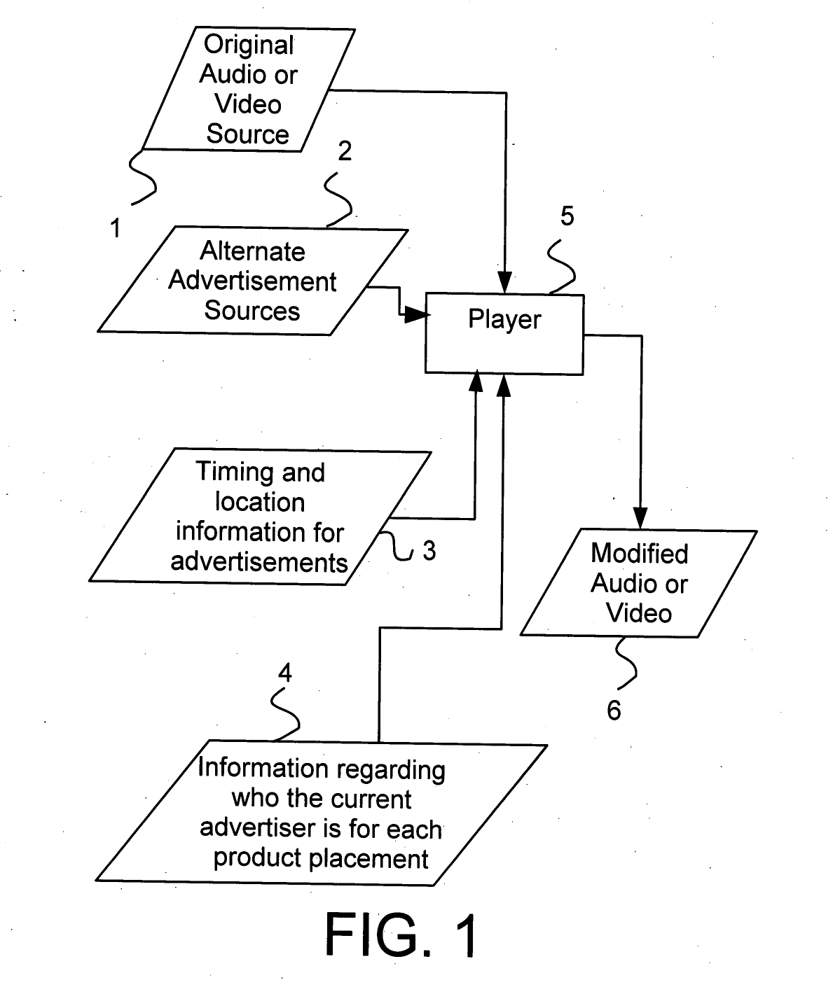

### FIG. 1—Preferred Embodiment

A preferred embodiment of the dynamic product placement system is illustrated in FIG. 1. The system starts with an original source 1 of audio or video data with which to use dynamic product placement. 2 represents examples of other product placement clips that could replace the original product placement in 1. These could be found through a variety of sources. Some examples include finding alternative product placement through a website, on a hard disk, or in the original audio or video source with 1. The product placement clips 2 can be created by simply re-recording the original scene multiple times using different product placements, or by using digital effects to manually replace the original product placement with new product placement.

In order for a player 5 to know when to play alternative clips, the player requires information 3 regarding when clips should be played and where to find the replacement clips. 3 can take the form of a simple spreadsheet, be interleaved in the original data stream 1, or take other forms.

With data 1, 2, and 3, the player now enough information to determine when product placement should happen. 5 also has the potential to show different product placement during the segment that the original product placement took place. In order for the player 5 to determine which product placement to use, it needs information 4 about who the current advertiser should be for this segment. The current advertiser could be determined in many different ways. One example is to simply auction off the product placements for a period of time. Another example is to base the product placement on the geographic location of the viewer or listener so that the advertisements are more relevant to the user. 4 can be based on other aspects of the viewer or listener as well, such as the viewer's age, or personal preferences. In any event, once the current advertiser 4 is determined, the player 5 now has enough information to replace the product placement in the original stream of data 1 with new data from the pool of product placement options 2. The result is the ability to show the viewer a modified version 6 of the original data containing different product placement from 1. This structure solves many of the problems with current advertising methods. First of all, the advertisement is embedded into the original media as product placement, so it is noninvasive. Secondly, because the player checks for substitute product placement while playing the data stream, the product placement advertising can be changed over time. Third, because a special player 5 is involved, even if the media is pirated, the player still checks for product placement and thus generates revenue for the owners of the media stream. Finally, because the data are product placements, viewers are discouraged from fast forwarding to skip the advertising because it is tied with the original program such that fast forwarding through the advertising would result in missing some of the original program as well.

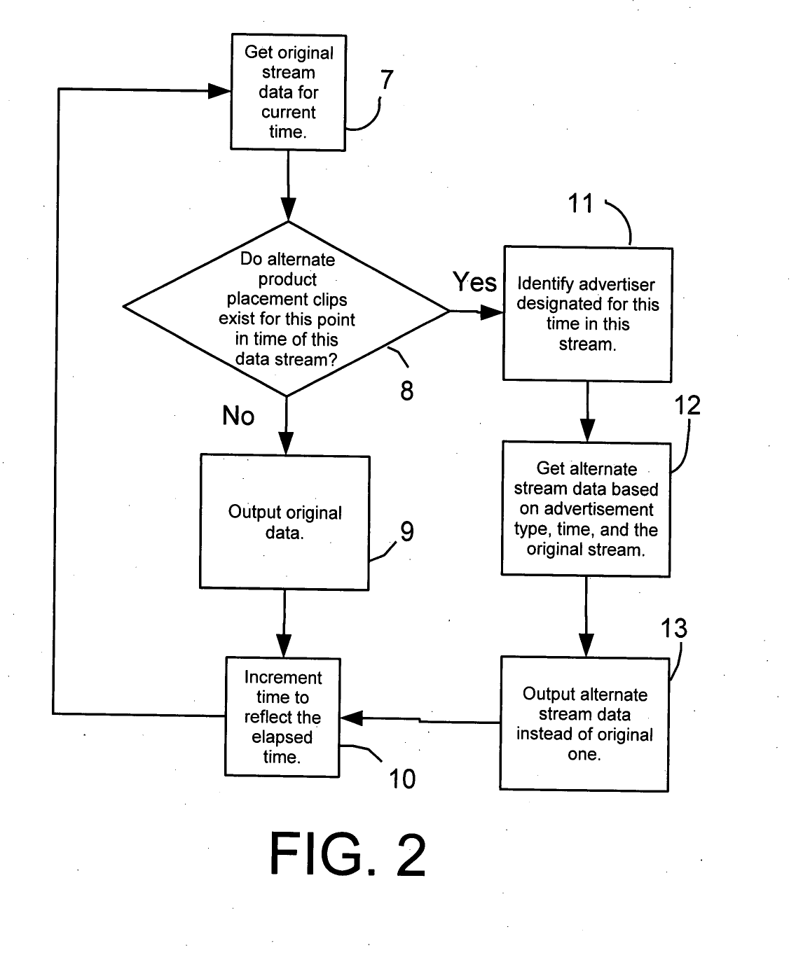

### FIG. 2—Example Player

FIG. 2 shows one possible method for how the player 5 could be implemented. For every unit of time that a data stream would be output, the following steps would occur. The player starts with step label 7, getting the data from the original stream designated for the current time. Then the player checks to see if the original stream should be used at this point in time, or if an alternate stream should be used instead. This check is done at step 8. If there is no alternate product placement for this stream, then the player outputs the original data 9, increments the time to the next logical time unit 10 and then goes back to step 7 to load the stream data for the next time unit. On the other hand, if there is alternate product placement for this stream at step 8, then the player goes to step 11 to identify the current advertiser. Now with enough information to choose which product placement to use, the player goes to step 12 and loads information relating to the alternate product placement. Finally, step 13 utilizes the data loaded in step 12 to output alternate stream data for this point in time. A simple way to do this is to simply replace the original data for this point in time with the data loaded in 12. Another way to do this if bandwidth is a concern is to use digital effects and somehow composite the new product placement into the original data. In any event, there is now new data to output for this stream at this point in time. The system can then move to the next point in time at step 10 and loop back to the beginning at step 7 to load data for the next point of time in the original data stream.

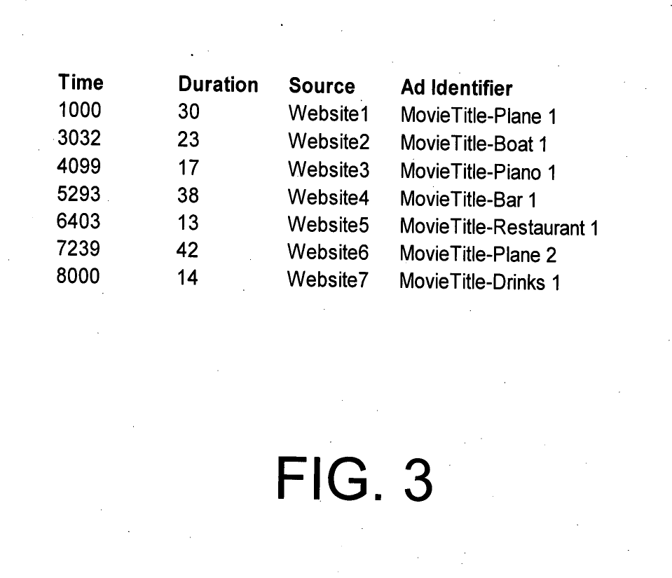

### FIG. 3—Example Timing and Location Information for Ads

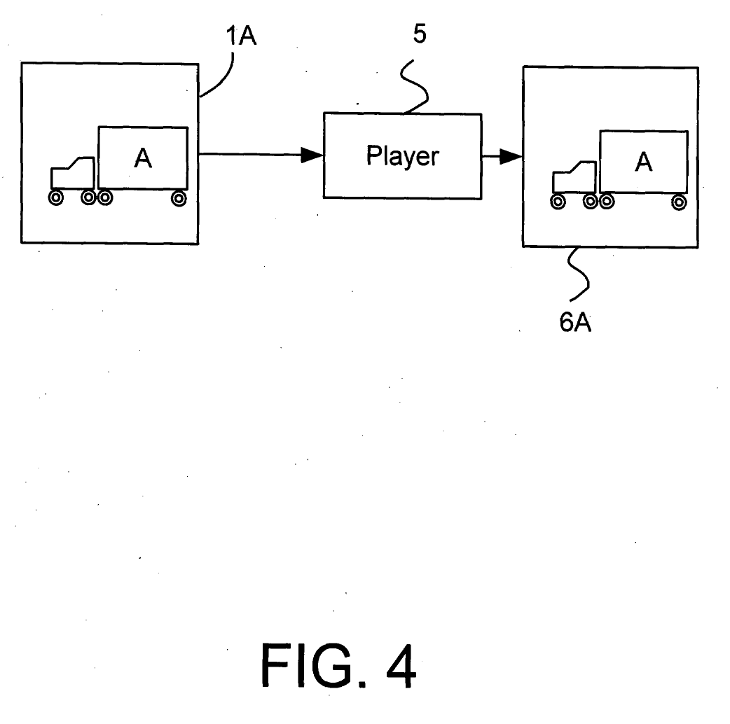

In FIG. 3 we show one way that the timing and location information 3 for the advertisements can be organized. In this case, it is a simple table which can be stored in a file as a spreadsheet or interleaved into the original data stream 1 such that the player can access the data at the correct points in time. In this example, we can see the titles of the clips, the website or file path to check for other advertisement clips 2, and when decisions should be made as to which clips to show during the playback of the data stream. FIGS. 4 to 7, show various examples of how the clip is altered for a particular element in the timing and location information. For simplicity, timing and location information 3 are not drawn; it is implicitly connected to the player 5 as in FIG. 1.

### FIG. 4—Current Streaming Media Example

FIG. 4 presents an example of how streaming media currently deals with product placement. Here a video signal with product placement for company A is labeled 1A in the figure. The player 5 takes in this signal and outputs a video signal 6A which has exactly the same product placement as the original video stream 1A.

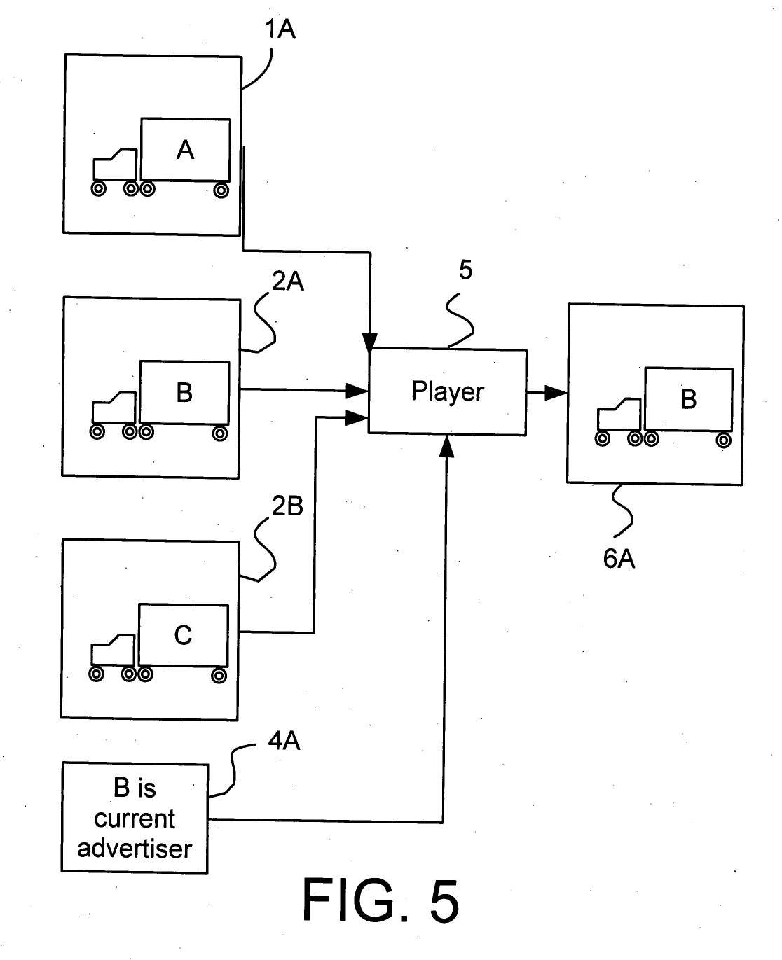

### FIG. 5—Dynamic Product Placement of Streaming Media Example

In contrast to FIG. 4, FIG. 5 has the same original video signal, 1A, but it also has other options for product placement at this point in time, namely items 2A and 2B. Item 4A indicates that, in this example the current advertiser should involve data from 2A. Because of the data from item 4A, the player 5 modifies the original video signal and the output 6A shows product placement information from signal 2A instead of that from signal 1A.

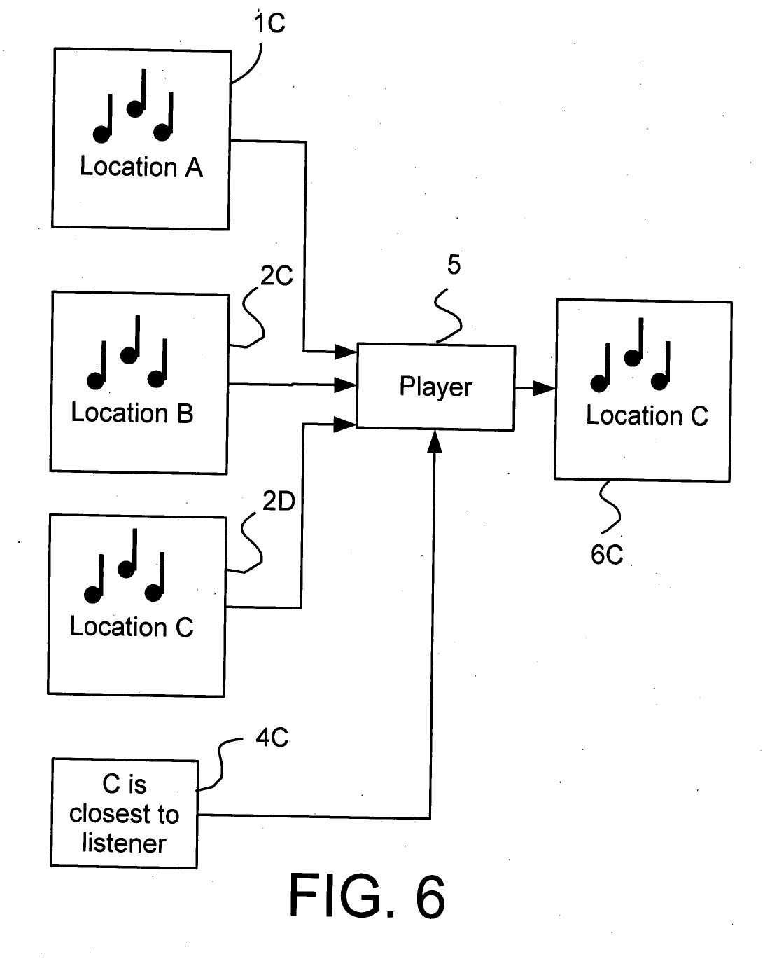

### FIG. 6—Dynamic Product Placement of Streaming Audio Example

FIG. 6 shows an example of how dynamic product placement can be done in audio as well as video. Rather than using video clips, as in FIG. 4 and FIG. 5, sound clips are used. The original audio stream 1C is piped into the player 5. For this particular clip the player knows there is product placement in which the audio includes sounds relevant to the location of the listener. Many different criteria can be used for selecting relevant advertisements, including incorporating the viewer's demographic, geographic location, or personal interests. For the purposes of demonstration, the criteria for determining which product placement to use 4C in this example is based on the location of the listener. One thing to note is the difference between item 4C in FIG. 6 and item 4A in FIG. 5. These are different instances of item 4 in FIG. 1. This shows that one can implement item 4 in many different ways. Because the example in FIG. 6 uses location based criteria, the output audio 6C is targeted to appeal to the listeners in that location and so in this case signal labeled 2D is utilized for the product placement.

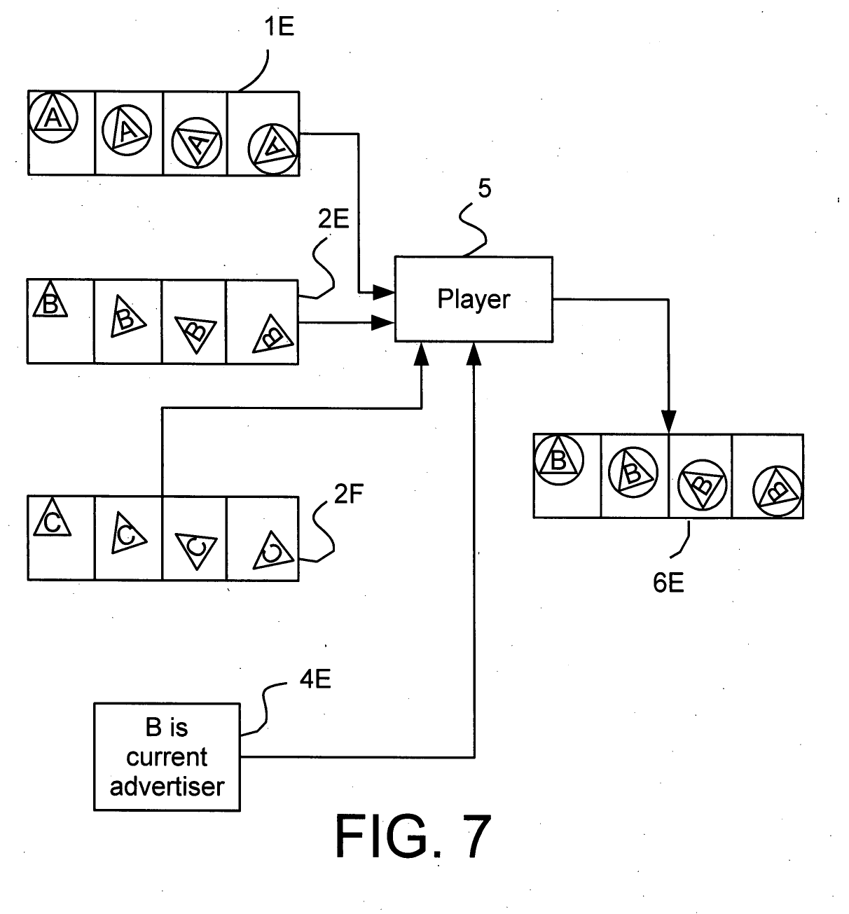

### FIG. 7—Dynamic Product Placement Utilizing Digital Effects

FIG. 7 offers a final example of how the technique of dynamic product placement can be implemented. In the previous examples of FIG. 5 and FIG. 6, the original clip is replaced with another clip. In this example, digital effects are used to merge the product placement with the original video stream 1E. Digital effects can be used offline to create completely new clips with which to replace the original clips. Because of potential bandwidth issues, streaming in completely new clips may not be feasible in some situations. In this case, with the emergence of powerful graphics processors, it is possible to use digital effects in real-time to effectively composite the product placement into the original data stream. In this example, we have smaller signals of other product placement in items 2E and 2F. Then, based on the information of which product placement to show 4E, item 2E is composited over the data in item 1E to show a new output with different product placement composited into the scene 2E. This technique has the disadvantage of being more complicated than simply replacing the original product placement clip with a new one. But for that disadvantage, there are a couple of key advantages for doing product placement with real-time digital manipulation. The first advantage is that the storage data required to composite image may be smaller than the storage required for a full clip, which can improve transmission of the data by utilizing less bandwidth for the product placement stream. The second advantage is that with digital effects it becomes easier for advertisers to submit their own ads for product placement. The original scene no longer has to be re-filmed or edited manually. Rather, because the digital effect information is stored in advance in 3, advertisers need only to submit new static images or geometries for their product placement. The static images can then be texture-mapped onto polygons and merged into the scene. Thus, the dynamic product placement method utilizing digital effects would effectively open up the product placement for this particular data stream to a larger group of advertisers.

What is claimed is:

1. A method of utilizing product placement dynamically for advertising in prerecorded video or audio comprising of:
a means of deciding when advertisements should occur in the video or audio stream;
a means of determining the content of an advertisement in a section of video or audio;
a means of altering sections of video or audio data such that the output data stream includes information relating to the advertisements;
a means of seamlessly playing back the audio or video data such that the altered sections of video or audio data can be used instead of the original product placement;

2. A method of advertising in prerecorded video or audio as claimed in claim 1 wherein prerecorded audio or video data is on a DVD, CD, HD-DVD, BluRay Disk, DVR, video game console, Internet source, or on a computer hard drive.

3. A method of advertising in prerecorded video or audio as claimed in claim 1 wherein said means of altering sections of video or audio data involves replacing an original section of audio or video with another section of video or audio containing an advertisement in some form.

4. A method of advertising in prerecorded video or audio as claimed in claim 1 wherein said means of altering sections of video or audio data involves compositing additional data over the top of the original data such that the additional data contains advertisement information in some form.

5. A method of advertising in prerecorded video or audio as claimed in claim 1 wherein said means of determining the content of an advertisement involves accessing the Internet prior to playing the section of video or audio in which the advertisement appears.

6. A method of advertising in prerecorded video or audio as claimed in claim 3 wherein the integrity of the original recording is maintained yet the advertisement in the original recording appears different to the audience.

7. A method of advertising in prerecorded video or audio as claimed in claim 1 wherein said means of determining the content of an advertisement comprises information about the audience such that the advertisement is contextual and geared to the audience.

8. A method of advertising in prerecorded video or audio as claimed in claim 1 wherein said means of determining the content of an advertisement comprises information about the geographic location where the content will be played.

9. A method of advertising in prerecorded video or audio as claimed in claim 1 wherein said means of determining the content of an advertisement comprises information about the demographic or interests of the viewer or listener.

10. A method of advertising in prerecorded video or audio as claimed in claim 1 wherein said means of determining the content of an advertisement comprises information about the amount of payment a company is willing to make in order to advertise in a particular section of video or audio.

11. A method of advertising in prerecorded video or audio as claimed in claim 1 further comprising of a player device which uses the advertisement information, the means of determining advertisement content, and the means of altering sections of video or audio, such that the player device has the ability to, alter the product placement of the original data stream into alternate product placement while the video or audio is being played.

12. A method of advertising in prerecorded video or audio as claimed in claim 1 wherein said prerecorded audio or video data is a computer file.
